(19) United States
(12) Patent Application Publication
(10) Pub. No.: US 2013/0090984 A1
(43) Pub. Date: Apr. 11, 2013

(54) CROWD-SOURCES SYSTEM FOR AUTOMATIC MODELING OF SUPPLY-CHAIN AND OWNERSHIP INTERDEPENDENCIES THROUGH NATURAL LANGUAGE MINING OF MEDIA DATA

(71) Applicants: Christofer Solheim, London (GB); Stoyan Mihov, Sofia (BG); Christopher Shaw, London (GB); Kiril Markov, Sofia (BG)

(72) Inventors: Christofer Solheim, London (GB); Stoyan Mihov, Sofia (BG); Christopher Shaw, London (GB); Kiril Markov, Sofia (BG)

(21) Appl. No.: 13/647,777

(22) Filed: Oct. 9, 2012

Related U.S. Application Data
(60) Provisional application No. 61/543,967, filed on Oct. 6, 2011.

(51) Int. Cl. G06Q 30/02

(52) U.S. Cl. 705/7.31

(57) ABSTRACT

According to some embodiments, natural language processing may be employed on media data to discover events pertaining to—and, including changes in—ownership (including mergers and acquisitions) and supplier/client relationships between corporations (and other entities) in such a manner that the system may maintain and automatically update a computerized model of the events and the attendant relationship between the entities, including but not limited to monitoring risk to corporate reputation across the supply chain.

### CROSS-REFERENCE TO RELATED APPLICATIONS

The present application claims the benefit U.S. Patent Application No. 61/543,967 filed on Oct. 6, 2012. The present application is also related to U.S. Pat. No. 7,933,843. The entire contents of those applications are incorporated herein by reference.

### BACKGROUND

In some cases, it may be important to figure out and understand supply-chain and/or corporate ownership information. For example, an investor might want to determine how a labor strike at an industrial plant will impact other businesses (e.g., businesses that supply parts to and/or receive parts from that industrial plant). Such information, however, can be difficult to determine, especially when the relationships between the various entities are complex.

It would therefore be desirable to provide systems and methods to facilitate understanding of such relationships in an automated, efficient, and accurate manner.

### SUMMARY OF THE INVENTION

According to some embodiments, systems, methods, apparatus, computer program code and means may provide a tool for extracting supply-chain relationships (and/or merger, acquisition, and ownership relations) for a plurality of business entities from textual data in media data.

Some embodiments provide: means for extracting supply-chain relationships (and/or merger, acquisition, and ownership relations) for a plurality of business entities from textual data in media data.

A technical effect of some embodiments of the invention is an improved and computerized method of extracting supply-chain relationships (and/or merger, acquisition, and ownership relations) for a plurality of business entities from textual data in media data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram illustrating supplier and ownership relations according to some embodiments of the present invention.

FIG. 2 illustrates a process wherein a semantic engine is associated with a computer executing natural language processing according to some embodiments.

FIG. 3 illustrates a flow of data according to some embodiments.

FIG. 4 illustrates a method for entity resolution that might be performed in accordance with some embodiments.

FIG. 5 illustrates a statistical frequency analysis according to some embodiments of the present invention.

FIG. 6 illustrates a name resolution system and process according to some embodiments of the present invention.

FIG. 7 illustrates processing associated with a news article according to some embodiments of the present invention.

FIG. 8 illustrates output of a linguistic and statistical process after entity resolution according to some embodiments of the present invention.

FIG. 9 illustrates some examples of supply chain information that might be extracted according to some embodiments of the present invention.

FIG. 10 is block diagram of a platform according to some embodiments of the present invention.

### DESCRIPTION

In some cases, it may be important to figure out and understand supply-chain and/or corporate ownership information. For example, an investor might want to determine how a labor strike at an industrial plant will impact other businesses (e.g., businesses that supply parts to and/or receive parts from that industrial plant). Such information, however, can be difficult to determine, especially when the relationships between the various entities are complex.

It would therefore be desirable to provide systems and methods to facilitate understanding of such relationships in an automated, efficient, and accurate manner. By way of example, consider relevant aspects of the business of Ford Motor Company that may exemplify the complexity and multiplicity of corporate relationships. When Ford completed its factory complex in 1928, it included private shipping docks (on the Rouge River), 100 miles of private railroad track, its own electricity plan and a facility for processing iron ore. It was the world's biggest integrated factory, minimizing dependencies on third party suppliers.

More than fifty years later another auto-giant, Toyota, invented the influential JIT (Just In Time) production strategy, based on the simple concept that inventory is waste. The objective is to have the “right material, at the right time, at the right place, and in the exact amount”, without the safety net of inventory. The JIT is often applied to several different layers in the supply chain of the company operating that particular supply strategy. This is not without risks; in the 1992 railway strike in the U.S., General Motors had to idle a plant employing 75,000 workers.

In 2010, Ford spent about $50 billion on parts purchases. Note that Ford is not only a buyer, it may also act as a seller. Nor do they sell all their products to individual end users. They are also a supplier to other firms, for instance to their dealers around the world, car-rental companies, shipyards and shipping/transport companies (e.g., the vehicle-rental company Hertz and the automobile brands Aston Martin, Jaguar, Land Rover and Volvo were subsidiaries of Ford).

In 2011 key suppliers to Ford Motor Company included may different entities, such as:

| Firm | Location | Product Category |
|---|---|---|
| Active Aero Group | Belleville, Mich., U.S. | Air Charter Logistics |
| Amara Raja Batteries | Andrah Pradesh, India | Warranty Improvement |
| Clifford Thames | Chelmsford, , UK | Data Processing |
| Cooper Standard | Mitchell, Ontario, | Mounts |
| | Canada | |
| Valeo Electrical | Czechowice, Poland | Starter Assemblies |
| Webasto | Schierling, Germany | Sliding Roofs |
| ZF Getriebe | Saarbrücken, Germany | Automatic |
| | | Transmissions |

Each year millions of media articles—news and other information categories such as (but not limited to) company financial filings, company press releases, company web-sites and financial/market analyst reports, opinions found in social media—refer to a supplier (or ownership) relationship between a business and another entity and secondary issues including but not limited to supply interruptions, ethical issues, corporate reputation risks.

For example, several published articles have referred to the fact that the Valeo corporation is a supplier to Ford. By analyzing the following sample article below with Natural Language Processing some embodiments described herein may automatically discover that Valeo is a supplier to Ford, as well as the product category in question.
VALEO: Presents Six Major Innovations at the Paris Motor Show 09/28/2012111:58 am US/Eastern
Valeo Presents Six Major Innovations at the Paris Motor Show Paris, Sep. 28, 2012—As one of the world's top automotive suppliers, Valeo is focusing its research and development on designing technologies to reduce carbon emissions on the vehicles of tomorrow. The company ranks among the leading patent filers in France, dedicating nearly 9% of its original equipment revenue to R&D. In coming years, the six technologies presented below will enable Valeo to consolidate its position as a leader in automotive innovation.
Hybrid4All: Valeo's hybrid technology makes it possible, for the first time, to offer hybrid powertrains on any vehicle and, more specifically, on entry-level models. By combining the Stop-Start function, regenerative braking and torque assist, Hybrid4all can deliver fuel savings of up to 15%. BiLED™ projector: This technology features on the full LED headlamps developed by Valeo for the new Ford Mondeo, which is making its world premiere at the Paris Motor Show.

According to some embodiments, Natural Language Processing techniques may be applied to such a news article (e.g., including the underlined portion) to automatically extract the following information to be supplied to a data model:
Product: LED Headlamps
Supplier: Valeo
Client: Ford
Source: www.4-traders.com
Date: 28 Sep. 2012

The relevant fields include but are not limited to: date of report, date of contract change, direction (win/loss), probability (possible, likely, definite), supplier name, customer name, product, size of contract in units or monetary value, geographic scope and source. By processing as many articles from as many sources as possible, a rich model can be built, containing the interdependencies of thousands of companies. The model can be extended with financial and stock market data on the companies in question as well as issues found in media and social media pertaining to the reputation, quality and other corporate reputation issues of the companies across the supply chain.

Almost all corporations are a part of the supply-chain; a disruption to the left of their own position can cause disruption in their production/service while a disruption to the right threatens their sales and revenues.

Understanding the supply chain of a corporation provides insight into their financial and operational risks, vitally important information for their customers, suppliers and for their equity investors, lenders and bond holders.

Using such a model it may possible to answer the following queries, including, but not limited to:

Company X has suffered a disruption. What other companies will be affected?

The city of X suffers from flooding, what are the products that depend on manufacturers from city X?

My corporation produces products X. Who are the big buyers of that now?

Corporation X has cancelled a contract with Y. Who else would like to supply X?

What corporation are the subjects of acquisition offers/attempt?

What are the subsidiaries of company X?

Supplier Y has suffered an ethical scandal (e.g., by using child labor)—how will that impact the reputation of company X that uses its products?

Moreover, such a data model may provide information to support KYC (Know-Your-Client) applications, Business Risk assessments, Impact analysis, Targeted sales and business developments, Investment analysis, and/or Corporate reputation risk assessments.

Business supply-chain information—what corporation is supplying what to whom—may be a key part of market research and company analysis. Information about corporate ownership structure may also be an important part of the business intelligence service of companies such as Dun & Bradstreet and others. Predictions about likely changes in contract and likely new merger and acquisition deals may be even more valuable as compared to reports on present and past relationships.

Traditional approaches of determining such data result have manual gathering and maintaining of the required information which are laborious and expensive.

According to some embodiments described herein, new methods of collecting, processing, predicting and/or presenting these types of data can provide labor and cost savings and improve the usefulness of the information and supplement and keep up to date existing data sets:

Collecting: some embodiments may utilize crowd-sourcing, drawing on all textual sources that may contain a reference to the relevant relationships. This includes but is not limited to news-sources, news-wires, PR-wires, corporate websites, transcripts or closed caption, archive and streaming, for radio and TV broadcasts

Moreover, some embodiments involve processing, including the use of Natural Language Processing to find, extract and structure the required information. Note there may be additional challenges to minimize the error-rate when processing unstructured text intended for human readers. Some embodiments described herein utilize a method to disambiguate the discovered references to named entities (such as company names). Appropriate disambiguation methods include but are not limited to contextual frequency analysis. These approaches may be further augmented by the inclusion of structured information from a multitude of sources.

Some embodiments described herein may predicting changes, examples of sub-methods include: loss of supplier contract is an indication that a new supplier will be considered, references to bids, consumer/client complaints. Note that through the use of Natural Language Processing embodiments may automatically identify certain topics and statements which are leading indicators of merger and acquisition activities. Leading indicators might be discovered using multiple systematical approaches to correlate media coverage (volume and context) with business actions. For example, statements of plans to focus on core activities can be a precursor to putting up a subsidiary for sale. Coverage on plans to expand geographically can also be a precursor for an acquisition. In some embodiments, exception reporting may be performed, such as when the frequency of citation of a business relationship has changed significantly.

Embodiments described here may also present information, such as by having the supply chain data be delivered as a simple data feed via XML. Derivative formats from this feed could also be, but not limited, to email alerts to supply chain changes. The information might also be presented as a navigable, inter-active map of inter-dependencies. Moreover, a whole database of entities, interdependencies (supply-chain and ownership) may also be made accessible to selected third parties and/or to the public through Application Program Interfaces.

Some embodiments described herein are associated with harvesting information using textual sources of information from which business relationships can de derived. The sources include but are not limited to news coverage, PR releases, consumer feedback, corporate financial statements and analyst reports, TV and radio broadcast (close caption or transcripts). The sources may be streaming or archived. Embodiments may also be associated with processing sources of information that are less structured than the sources traditionally used to discover business relationships. Some embodiments are associated with methods for disambiguating company names (and other entities including brands) referred to in the news sources.

Some embodiments are associated with processes to identify business and time sensitive changes in business relationships. This may be done by assessing the magnitude of a new event, the monetary value relative to subject company revenues. Also, the number of articles in respect of a contract being awarded might be a proxy for how important it is that the contract has been lost.

Some embodiments are associated with predictions, such as processes to predict significant business and time sensitive changes in the business relationships. Moreover, information service reporting may allow a user of the service to “navigate” the business relationships using interactive or static maps, receive emails alerts to supply chain changes, and/or identify risk factors across a supply chain.

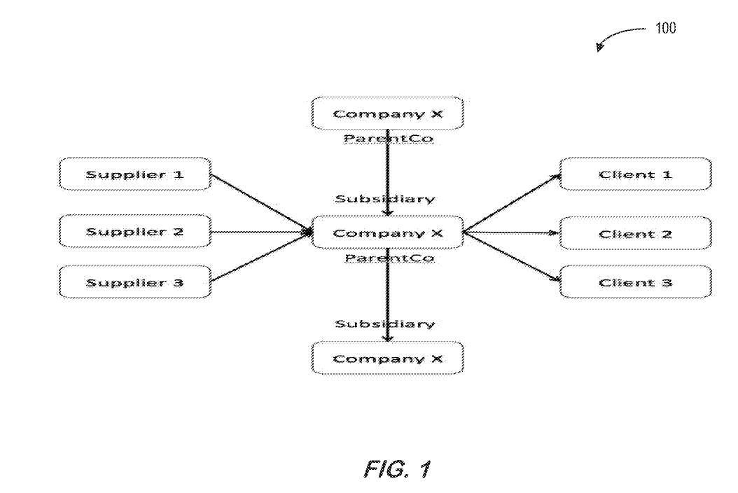

FIG. 1 is block diagram 100 illustrating supplier and ownership relations according to some embodiments of the present invention. In particular, the diagram 100 illustrates schematically the two types of relationships associated with embodiments described herein, namely (1) supplier/client relationships and (2) ownership relationships.

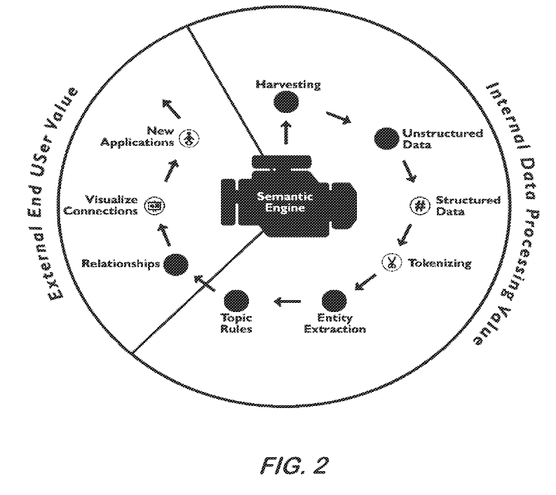

FIG. 2 illustrates a process 200 wherein a semantic engine is associated with a computer executing natural language processing according to some embodiments. Note how structured data may optionally be used to augment to information derivable from the unstructured data. Tokenizing is an optional step and refers to codifying the words and terms used in the unstructured text into types of words. Entity extraction extracts the names of companies and brands. Topic rules are applied to establish the nature of a relationship between two entities and the event that is reported. The computational linguistics for the topic rule step in the process 200 can optionally be conducted using a statistical approach instead of rules. The topic step may also be used to assign probability of an event and or to assign a time-point to the event. For instance, there is a high likelihood that company X will cease to purchase from company Y within 12 months.

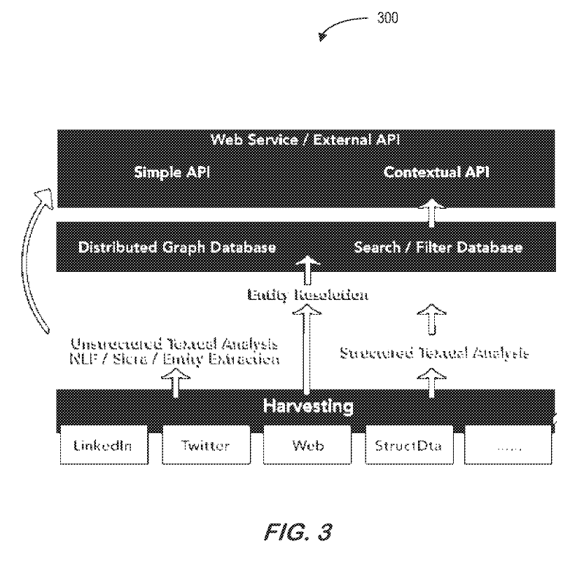

FIG. 3 illustrates a flow 300 of data. Note how structured data may optionally be added and the key point of entity resolution. In accordance with the flow 300, various sources may be harvested, entity resolution may be performed, and the results may be available via a web service and/or API via a distributed graph database and/or a search/filter database.

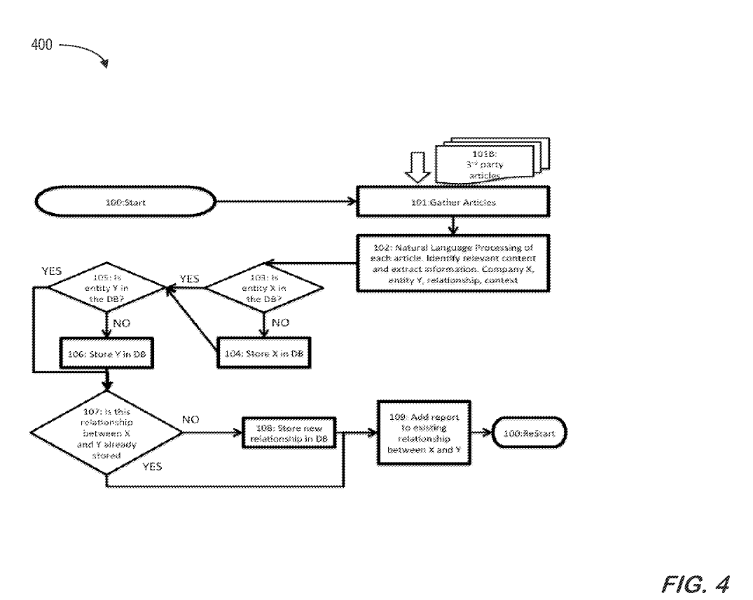

FIG. 4 illustrates a summary of an entity resolution method 400 according to some embodiments. In particular, articles are gathered and NLP processing is performed on the articles to identify relevant content and extract information about entity X and entity Y. If needed, the information may be stored into a database along with the relationship between those entities.

In practice, a textual entity extraction process might produce a list of organization names found, such as:

Omega Contract, Omega Inc., Pfizer Inc., Omega

Note that the entity extraction itself might not be able to determine if “Omega Contract” is a company name. However, the initial steps of the entity resolution logic would be programmed to prefer the name “Omega Inc.” (or Ltd, S.A., LLC, B.V. and other tags which help disambiguate to a specific company and jurisdiction).

Two names may therefore emerge from the above linguistic analysis: “Omega Inc.” and “Pfizer Inc.” The resolution of these entities to specific, unique company entries in the database may be non-trivial, given that there may be several companies by those names.

If, by way of example, one assumes that the initial steps of the entity resolution logic produces an output of “Caterpillar Inc” and that is at least a part of the formal name of a business, there could be several companies with very similar names, often in different industries.

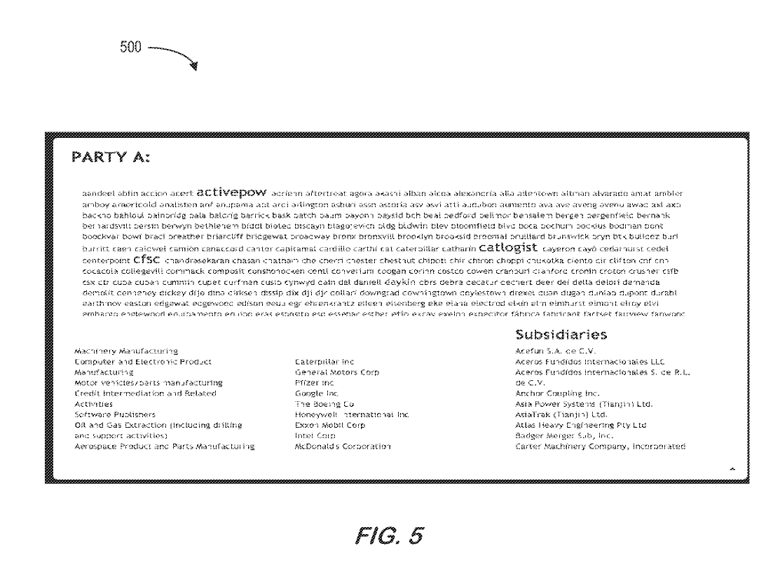

FIG. 5 is a display 500 illustrating a specific implementation of statistical frequency analysis based on likelihood ratios to improve the named entity resolution accuracy. The top part of the display 500 identifies terms that occur frequently in articles about Caterpillar Inc. PARTY A in this context means that Caterpillar Inc. has been identified as the name of a customer (as opposed to supplier).

For each industry a word/term frequency table may be calculated. By comparing the frequency profile for the words in the article referring to Caterpillar Inc it may be determined if the article likely refers to an industry associated with Caterpillar or their suppliers/clients. Note how an article on Caterpillar supplying machinery to an oil company may refer both to the machine manufacturing and energy sectors. If the counter-party discovered by the textual analysis is Boeing Inc, the frequency data may provide the additional reassurance that the two firms have often appeared in the same business context. If, on the other hand, the counter-party proposed by the textual analysis is AsiaTrak, it is not likely to be the correct counter-party as it is a subsidiary of Caterpillar.

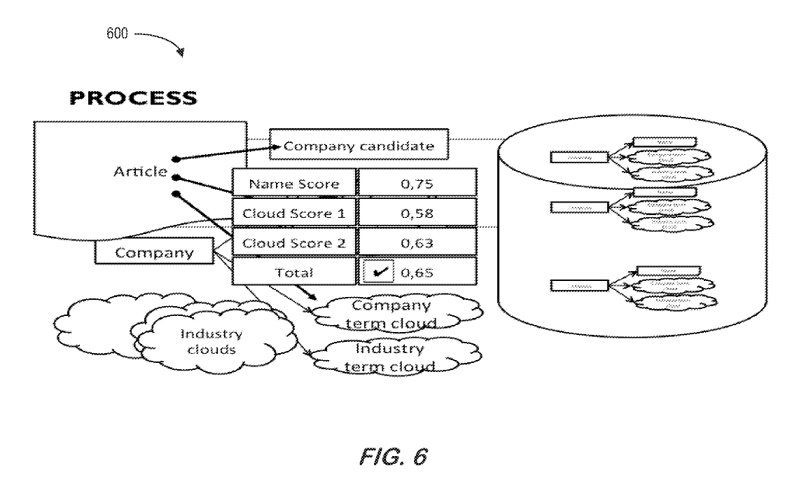

Each organization name identified in the articles as a party to a client/supplier relationship is subjected to a name resolution process. By way of example, FIG. 6 illustrates a name resolution process 600. When entity extraction has identified a string, which is likely to be a reference to a company name (or other named entity), the process 600 will retrieve candidate companies already stored in the database, whose names are similar. This may be done by string comparison and it may produce a long list of candidates because the comparison is relaxed to allow for the fact that many writers refer to companies in informal ways.

Each unique candidate corporation from the database may be associated with a term frequency cloud. That cloud for each company may be compared with the term frequency cloud of the article in question. Close matching provides a high score.

The article term cloud may then be compared with the term clouds for each industry. Based on this, the article might be associated with a certain number of industries. Companies who operate in those industries may be given a higher score.

The total score might be based on, for example: a strong name string similarity contributes to a high score; close similarity between the candidate term cloud and the article cloud contributes to a high score; close industry association with at least one of the industries that have similar clouds to the article contributes to a high score; frequent historical co-citation between other entities mentioned in the article contributes to a high score; and/or if the company name is a close match to a subsidiary of the other party, then the score might be reduced.

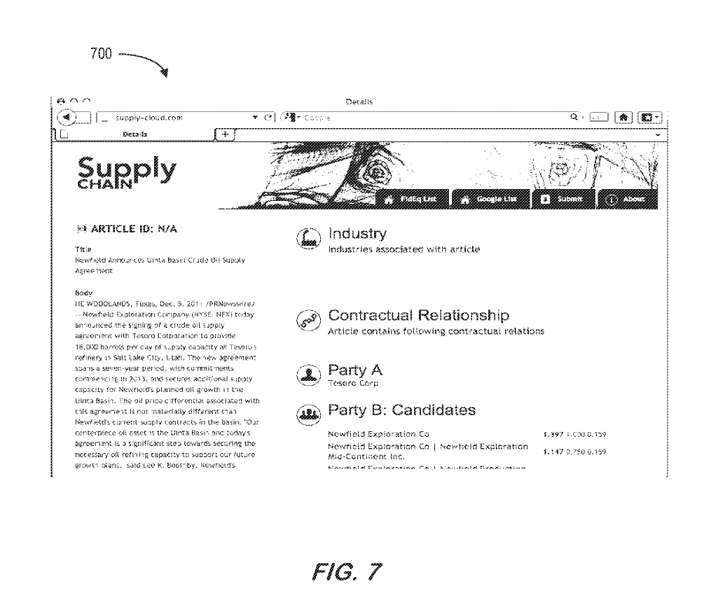

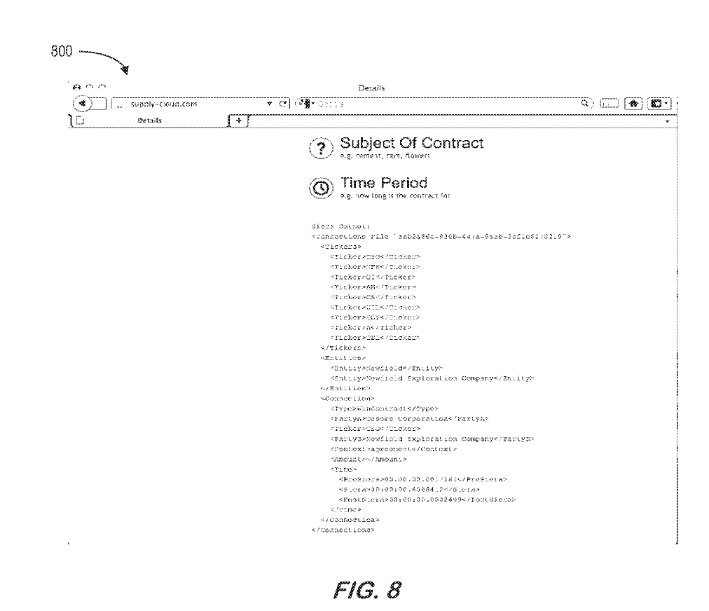

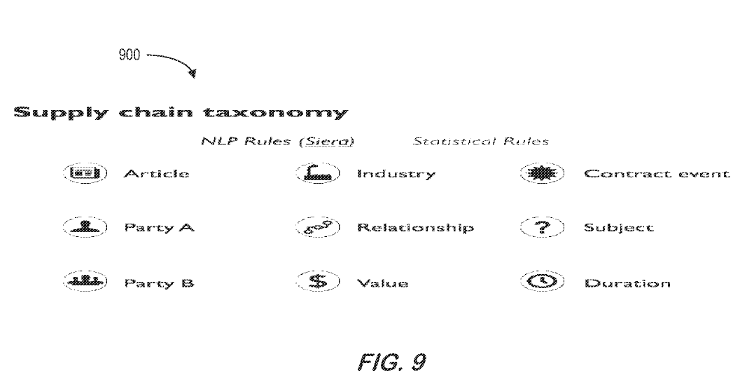

FIG. 7 is a display 700 illustrating processing of an article referring to the “Tesoro Corporation” winning a contract from “Newfield Exploration Company”. FIG. 8 illustrates the output 800 of linguistic and statistical processing, after the entity resolution. Note that there may be an optional manual control step before the data are added to the database of relationships. FIG. 9 is an illustration 900 of some of the supply chain information elements that can be extracted using embodiments described herein. Note that all techniques associated with supplier relationships may also be used to extract ownership information and merger and acquisition plans.

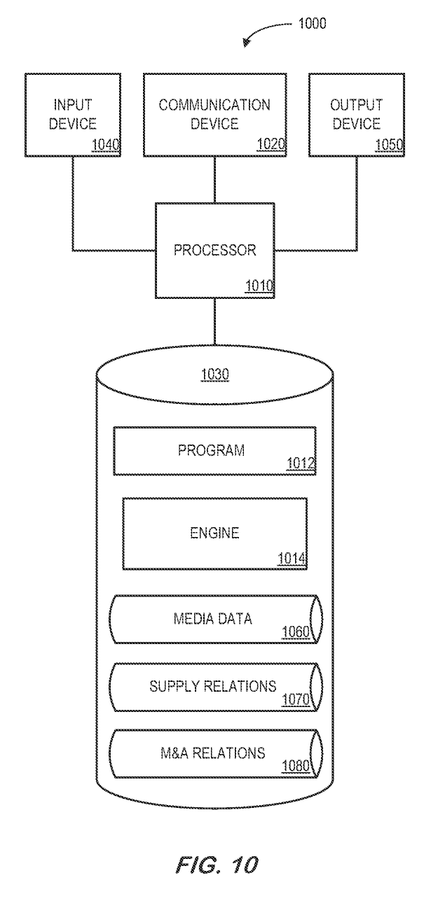

The embodiments described herein may be implemented using any number of different hardware configurations. For example, FIG. 10 illustrates a platform 1000 that may be, for example, associated with any of the embodiments described herein. The platform 1000 comprises a processor 1010, such as one or more commercially available Central Processing Units (CPUs) in the form of one-chip microprocessors, coupled to a communication device 1020 configured to communicate via a communication network (not shown in FIG. 10). The communication device 1020 may be used to communicate, for example, with one or more remote news feeds or sources. The platform 1000 further includes an input device 1040 (e.g., a mouse and/or keyboard to enter business information) and an output device 1050 (e.g., a computer monitor to display supplier and ownership relationships).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or an engine 1014 for controlling the processor 1010. The processor 1010 performs instructions of the programs 1012, 1014, and thereby operates in accordance with any of the embodiments described herein. For example, the processor 1010 may automatically identify sources (e.g., media data 1060) containing information on contracts being awarded, disrupted, reduced, extended or lost. The processor 1010 may also identify from a plurality of sources the companies to be tracked and/or extract from stock exchanges the comprehensive schedule of companies whose equities or bonds are traded on that exchange. Using automatic named entity extraction (part of Natural Language Processing), the processor 1010 may extract the names of organizations referenced in the text. Using rule-based or statistical NLP processes to identify which of the organizations are associated with contracts.

According to some embodiments, the processor 1010 may set up the data depositories, such as a supply relations database 1070 and/or a merger and acquisitions database 1080. The processor 1010 might generate the base-line model by processing all articles from a certain historical date, extract using NLP the name(s) of the supplier(s), extract using NLP the name(s) of customer(s), and disambiguate the names of both supplier(s) and customer(s).

According to some embodiments, the processor 1010 may extract using NLP the value of the contract (if any), extract using NLP the event type (win, loss, extend, reduce), extract using NLP a degree of likelihood (“has won”=certain while “might win is not certain), extract the date of publication, and/or extract the name of the publication. According to some embodiments, the processor 1010 might perform such steps on an on-going basis (e.g., each time a new discovery of a contractual change is made).

Moreover, the processor 1010 might determine if the model already contains the information (match on disambiguated supplier, match on disambiguated customer, similarity on value (if any), and proximity on date). If yes, the processor 1010 may store article event as supporting data for the contract event. If no, the processor 1010 might add to contract event.

According to some embodiments, the processor 1010 may communicate any model-changes to other companies that maintain models supported by additional sources or processes.

The processor 1010 may also predicting changes, such as predictions associated with a loss of supplier contract which is an indication that a new supplier will be considered, references to bids, and/and consumer/client complaints. According to some embodiments, the use of Natural Language Processing may automatically identify certain topics and statements which are leading indicators of merger and acquisition activities. Statements of plans to focus on core activities can be a precursor to putting up a subsidiary for sale. Coverage on plans to expand geographically can be a precursor for an acquisition. The processor may also handle exception reporting (e.g., when the frequency of citation of a business relationship has changed significantly).

According to some embodiments, the processor 1010 may present information, such as by delivering the supply chain data as a simple data feed, such as but not limited to XML. Derivative formats from this feed could also be but not limited to email alerts to supply chain changes. Information may also be presented as a navigable, inter-active map of inter-dependencies. According to some embodiments, a whole database of entities, interdependencies (supply-chain and ownership) may also be accessible to selected third parties and/or to the public through Application Program Interfaces. Moreover, the processor 1010 may allow users to interrogate the model through a computer-user interface to determine, for example:

Who are the suppliers for company X?

Who are the suppliers and customers for company X, reported with Y degrees of separation?

What companies in the supply chain of company X has recently lost contracts?

What is the distance between company X and company Y, and what are the companies between them?

The programs 1012, 1014 may be stored in a compressed, uncompiled and/or encrypted format. The programs 1012, 1014 may furthermore include other program elements, such as an operating system, a database management system, and/or device drivers used by the processor 1010 to interface with peripheral devices.

As used herein, information may be “received” by or “transmitted” to, for example: (i) the tool 1000 from another device; or (ii) a software application or module within the tool 1000 from another software application, module, or any other source.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system, comprising:
a communication device to receive media data;
a computer processor for executing program instructions; and
a memory, coupled to the computer processor, for storing program instructions for execution by the computer processor for:
extracting supply-chain relationships for a plurality of business entities from textual data in the media data.

2. A system, comprising:
a communication device to receive media data;
a computer processor for executing program instructions; and
a memory, coupled to the computer processor, for storing program instructions for execution by the computer processor for:
disambiguating at least one business entity name in the media data, and
extracting supply-chain relationships for a plurality of business entities from textual data, including the disambiguated business entity name, in the media data.

3. A system, comprising:
a communication device to receive media data;
a computer processor for executing program instructions; and
a memory, coupled to the computer processor, for storing program instructions for execution by the computer processor for:
extracting supply-chain relationships for a plurality of business entities from textual data in the media data,
identifying at least one time-sensitive change in the supply-chain relationships, and
reporting an exception in response to said identifying.

4. A system, comprising:
a communication device to receive media data;
a computer processor for executing program instructions; and
a memory, coupled to the computer processor, for storing program instructions for execution by the computer processor for:
extracting supply-chain relationships for a plurality of business entities from textual data in the media data,
predicting at least one time-sensitive change in the supply-chain relationships that may occur in the future.

5. A system, comprising:
a communication device to receive media data;
a computer processor for executing program instructions; and
a memory, coupled to the computer processor, for storing program instructions for execution by the computer processor for:
extracting supply-chain relationships for a plurality of business entities from textual data in the media data,
creating a map of the supply-chain relationships for the plurality of business entities, and
allowing a user to navigate within the map to receive in formation about the plurality of business entities.

6. A system, comprising:
a communication device to receive media data;
a computer processor for executing program instructions; and
a memory, coupled to the computer processor, for storing program instructions for execution by the computer processor for:
extracting merger, acquisition, and ownership relations for a plurality of business entities from textual data in the media data.

7. A system, comprising:
a communication device to receive media data;
a computer processor for executing program instructions; and
a memory, coupled to the computer processor, for storing program instructions for execution by the computer processor for:
disambiguating at least one business entity name in the media data, and
extracting merger, acquisition, and ownership relations for a plurality of business entities from textual data, including the disambiguated business entity name, in the media data.

8. A system, comprising:
a communication device to receive media data;
a computer processor for executing program instructions; and
a memory, coupled to the computer processor, for storing program instructions for execution by the computer processor for:
extracting merger, acquisition, and ownership relations for a plurality of business entities from textual data in the media data,
identifying at least one time-sensitive change in the merger, acquisition, and ownership relations, and
reporting an exception in response to said identifying.

9. A system, comprising:
a communication device to receive media data;
a computer processor for executing program instructions; and
a memory, coupled to the computer processor, for storing program instructions for execution by the computer processor for:
extracting merger, acquisition, and ownership relations for a plurality of business entities from textual data in the media data,
predicting at least one time-sensitive change in the merger, acquisition, and ownership relations that may occur in the future.

10. A system, comprising:
a communication device to receive media data;
a computer processor for executing program instructions; and
a memory, coupled to the computer processor, for storing program instructions for execution by the computer processor for:
extracting merger, acquisition, and ownership relations for a plurality of business entities from textual data in the media data,
creating a map of the merger, acquisition, and ownership relations for the plurality of business entities, and
allowing a user to navigate within the map to receive in formation about the plurality of business entities.
